(19) United States
(12) Patent Application Publication
(10) Pub. No.: US 2018/0134133 A1
(43) Pub. Date: May 17, 2018

(54) PUSHING AND/OR PULLING DEVICE FOR A VEHICLE TOP AND TOP FOR AN OPENABLE VEHICLE ROOF

(71) Applicant: AUDI AG, Ingolstadt (DE)

(72) Inventor: Andreas Dillinger, Kelheim (DE)

(73) Assignee: AUDI AG, Ingolstadt (DE)

(21) Appl. No.: 15/572,892

(22) PCT Filed: Oct. 28, 2016
(86) PCT No.: PCT/EP2016/001806

§ 371 Date: Nov. 9, 2017

(30) Foreign Application Priority Data
Nov. 20, 2015 (DE) 102015015064.2

(51) Int. Cl. B60J 7/14

(52) U.S. Cl. CPC B60J 7/143

(57) ABSTRACT

A pushing and/or pulling device for a vehicle top, with two link chains, which are respectively provided with a plurality of link elements and extend at a predetermined distance to each other. The link chains are respectively guided at one end in a guide, which defines a movement direction and a distance of the link chains to each other, which are connected at the other end via a transverse connection to each other, so that the link chains extend upon exiting the guide in a joint plane. Two adjacent link elements of the link chains are movably connected to each other via a joint, so that at least one part of the link elements is upon entering the link chains put away in the respective guide in a corresponding storage area.

The invention relates to a pushing and/or pulling device for a vehicle top of the type according to patent claim 1 and to a corresponding top for an openable vehicle roof provided with such a pushing and/pulling device.

Folding tops for openable roofs are known in many variations. Usually, the tops have at least two folding top sections, wherein a first top section in front can be coupled to a windshield cross-member and the second top section in the rear is provided with a flat rear window. These folding tops are mostly moved over a pivot point, wherein the convertible top is moved high above the vehicle. Because this requires an enormous expenditure of force, robust and heavy drive mechanisms and drives must be used. The folding of the top is ensured for example with scissor joints. As an alternative to the embodiment with a folding top section, a top section can be also guided between the longitudinal members of the vehicle roof. This means that at least one top section is designed to be displaceable.

From DE 197 04 846 A1 is known a top for a motorized minimalist personal motor vehicle, which is in particular designed as a so called roadster or speedster. In these personal vehicles, a top center part is pivotally mounted on a rear part between a location below a seat position and a raised position supported on an upper edge of a windshield. Two collapsible tops guided by the top center part can be pushed forward over the seat position, so that in the raised position of the top center part, they are in a hidden position behind the seat positions.

From DE 101 20 358 A1 is known a vehicle that is provided with a top for an openable roof. The vehicle has two removable roof frames with rear C columns that are connected to it. A displaceable roof element, in particular a folding and sliding roof, or a slatted roof, is accommodated in the guides of the lateral roof frames. A flat rear roof element, in particular a rear window, is pivotally mounted on the vehicle body. The displaceable roof element is in a fully opened rear end position accommodated in a receiving region that is associated with the flat roof element.

From DE 10 2004 003 021 A1 is known a cabriolet vehicle which is provided with at least a partially openable roof equipped with a flexible cover, which comprises in its front roof region a rigid end region that is covered by this cover. The front roof region can be created in the same orientation as in the closed roof state in a vehicle body recess, which is to say so that it has a surface of the front roof region that opens upward with the closed roof state. The roof can for this purpose be pulled away in a so-called Z fold, so that a Z-shaped cover is created with a section with the roof peak, as well as with a lower section around the rear window and a with a diagonally connected intermediate section that is pulled down. The front roof section further comprises a longitudinally displaceable additional carrier, which is arranged below the cover and which is movable via a pull-push link relative to the cover.

The object of the invention is to provide a pushing and/or pulling device for a vehicle top as well as a convertible top for an openable vehicle roof that is equipped with such a pushing and-or pulling device, and which has several folding top sections of the openable vehicle roof that can be opened with a small force expenditure between a closed usage position and a non-visible usage position, and which occupies in the non-usage position a smaller space than conventional pushing and/or pulling constructions.

The object is achieved according to the invention by providing a pushing and/or pulling device for a vehicle top having the features of patent claim 1 and a top for an opening vehicle roof having the features of claim 13. Advantageous embodiments and further developments of the invention are described in the dependent claims.

In order to provide a pushing and/or pulling device for a vehicle top, which accommodates several top sections of the openable vehicle roof and which can be moved by applying a small between a closed usage position and a non-visible non-usage position, and which also occupies a smaller space than conventional pushing and/or pulling constructions, two link chains are provided, which are respectively provided with a plurality of link elements and which are arranged at a predetermined distance to each other. The link chains are respectively guided at one end in a guide, which predetermines the direction of the movement and the distance of the link chains to each other, and at the other end they are connected by means of a transverse connection, so that the link chains extend on a common plane upon leaving the guide. In addition, two adjacent link elements of the link chains are movably connected to each other via a link, so that at least one part of the link elements is placed in the corresponding guide in a corresponding position when the link element enters in the respective guide, wherein when the adjacent link elements exit the respective guide, they are lying against each other and support each other. In this case, the pivot axes between the two adjacent elements of the respective link chains have a predetermined inclination, or they are parallel to each other, so that the link chains extend freely in the direction of the predetermined movement, and so that they mutually block each other with respect to movement in other directions.

By means of the described alignment of the pivot axes of the adjacent link element, the self-supporting pushing and/or pulling device can be represented with two link chains, which can be in the relaxed or flexible state simply rolled up and/or stored in a storage area. The self-supporting effect is produced by the distance between the link chains via the transverse connection at one end of the link chains, or by the distance between the link chains upon the exiting of the respective guide, which results in a mutual support of the link chains for each other, and which is produced after the guides leave the mutually self-supporting adjacent link elements.

The adjacent link elements of the respective link chains are connected to each other in such a way that they can be pivoted relative to each other only about a predetermined pivot axis. This means that the adjacent link element of a first link chain can only pivot about a first pivot axis, and the first adjacent link chains of the link chains can thus be movably interconnected via one link, so that at least one part of the link element is placed in a corresponding storage area, whereby the adjacent link elements are supported against each other upon exiting the respective guides and mutually support each other when a force acts in the opposite direction of the respective pivot axis, because the adjacent link elements are in contact with each other and prevent bending. With the pivot axes of the first link chain and of the second link chain oriented against each other, the first link chain blocks by means of the predetermined distance bending of the second link chain about the second pivot axes, and the second link chain blocks by means of the predetermined distance bending of the link chain about the second first pivot axes.

In summary, both link chains or both pivot axes are tilted in opposite directions, they are connected at the free ends via the transverse connection at the predetermined distance to one another, and they exist the guide at a predetermined distance to each other. In this manner, both link chains reinforce each other in a cross-section to form a “V” or a reverse “V” shape, or a U. Therefore, it is possible for a self-supporting element arranged at the connected ends of the link chain to be pushed out of guide without leaving the predetermined direction.

The link between two adjacent link elements can be represented for example as a hinge, which can move “only” as a pivoting wing. However, it is also conceivable that the link permits twisting of the adjacent link element in the deposited position and that it is designed for example as a ball joint. In this case, the contacting elements of the adjacent link elements are formed in such a way so as to be mutually opposed upon contact. This can be represented for example by a “tongue and groove system”, which is provided with the corresponding recesses and projections. By means of the movable connection between two adjacent link element, the freedom of movement of both link chains can be advantageously increased and the link chains can be deposited in the storage area location in a space-saving manner.

In addition, a folding top for an openable vehicle roof is proposed, which has several folding top sections and which is provided with the pushing and/or pulling device, which moves the folding top sections from a usage position to a non-usage position.

In an advantageous embodiment of the pushing and/or pulling device according to the invention, the inclination angles of the pivot axes to a common plane can be predetermined in a value range from more than 0° to less than 180°. It is preferred when the inclination angle is selected in a value range between 45° and 135°.

In another advantageous embodiment of the pushing and/or pulling device according to the invention, the link can be designed as hinge with a fixed pivot axis, or as a ball joint with variable pivot axes. The embodiment as a hinge makes it possible to obtain a particularly simple and inexpensive realization of the pushing and/or pulling device, while the embodiment as a ball joint makes it possible to achieve a better matching of the pushing and/or pulling device with the given installation environment. Adjacent link elements that are connected by means of a ball joint can be provided with additional guide contours which support the adjacent link elements when they exit the respective guide. Therefore, a first guide contour can be realized for example as a recess and a second contour can be realized as a projection.

In another advantageous embodiment of the pushing and/or pulling device according to the invention, the guide can be provided with at least one drive element that is coupled to a drive, which can move the respective link chain. The at least one drive element can be designed for instance as a traction cable, or as a toothed wheel, a traction wheel, a worm wheel, or a belt.

In another advantageous embodiment of the pushing and/or pulling device according to the invention, the guide can comprise a load-bearing end section and a connecting section, which can predetermine a curved path for the corresponding link chain between the load-bearing end section and the storage area position. It is preferred when the load-bearing end section and/or the connecting section and/or the storage area can be designed as inexpensive guide rails, which can be arranged inside the link elements. The link elements can thus surround the load-bearing end section and/or the connecting section and/or the storage area partially or completely, so that the guide is not visible and so that no visible signs of the link chain can be seen on the outer side.

In another advantageous embodiment of the pushing and/or pulling device according to the invention, the load-carrying end section and/or the connecting section and/or the storage area can be designed as guide rails that can accommodate the link elements.

In another advantageous embodiment of the pushing and/or pulling device, the link elements can be respectively provided with at least one guiding element, which is conducted before exiting guide into the load-carrying end section. The load-carrying end section of the guide makes it possible that the respective link elements are held in the guide and are picked up from the “angled” connecting section in such a manner that they are in the respective direction of the transverse connection in contact with the adjacent link element. This can in particular ensure that several friction wheels, toothed wheels, or the like will be placed correctly as required.

In another advantageous embodiment of the pushing and/or pulling device according to the invention, individual link elements of the respective link chains can have the same or different dimensions and/or shapes. As a result, the pushing and/or pulling device can be advantageously fitted in a simple manner to various different embodiments of the folding top.

In an advantageous embodiment of the folding top according to the invention, the front folding top section can be designed as a rigid roof top, which can be connected with at least one intermediate part to a rear rigid folding top section that can be provided with a rear window.

In another advantageous embodiment of the folding top according to the invention, the front folding top can form the transverse connection between the two link chains. In addition, the front folding top can be arranged in the non-usage position above or below the rear rigid folding stop section.

In another advantageous embodiment of the folding top according to the invention, a window seal can be provided with a receiving slot, which can be provided on the link element and into which can be inserted a free edge of a side window.

Embodiments of the invention illustrated in the figures will be explained next in more detail. The same reference symbols are used for designation of the same components or elements representing the same or analogous functions. The figures show the following:

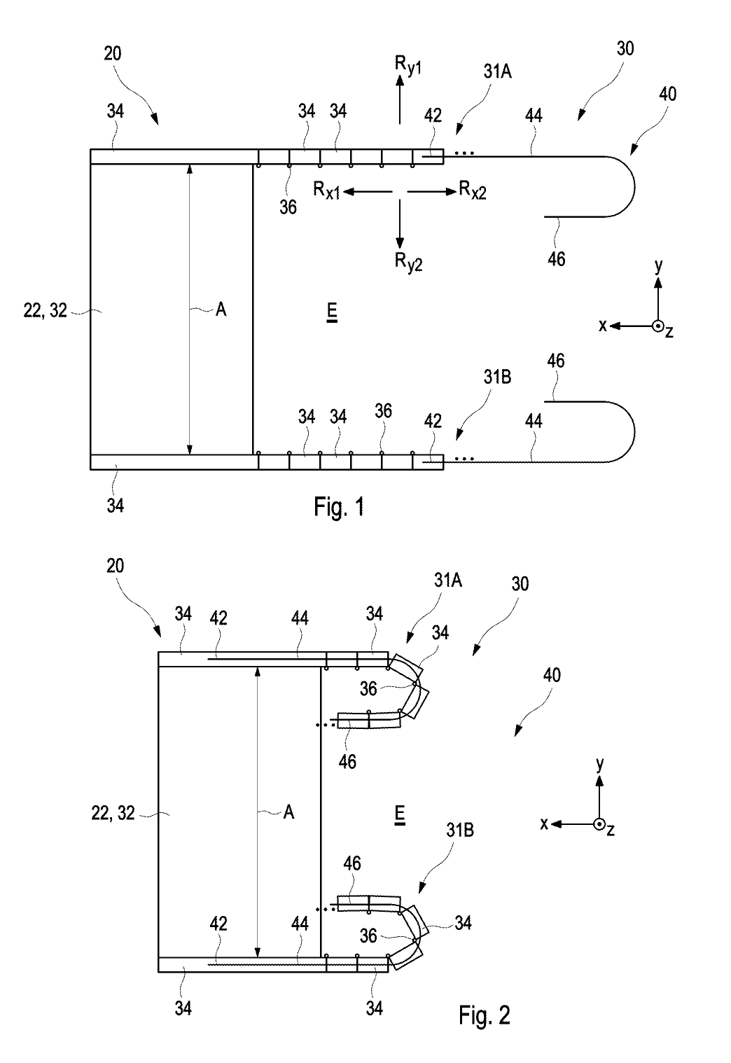

FIG. 1 a schematic representation of an embodiment of a pushing and/or pulling device for a vehicle top in a usage position,

FIG. 2 a schematic representation of the pushing and/or pulling device according to the invention of FIG. 1 in a non-usage position,

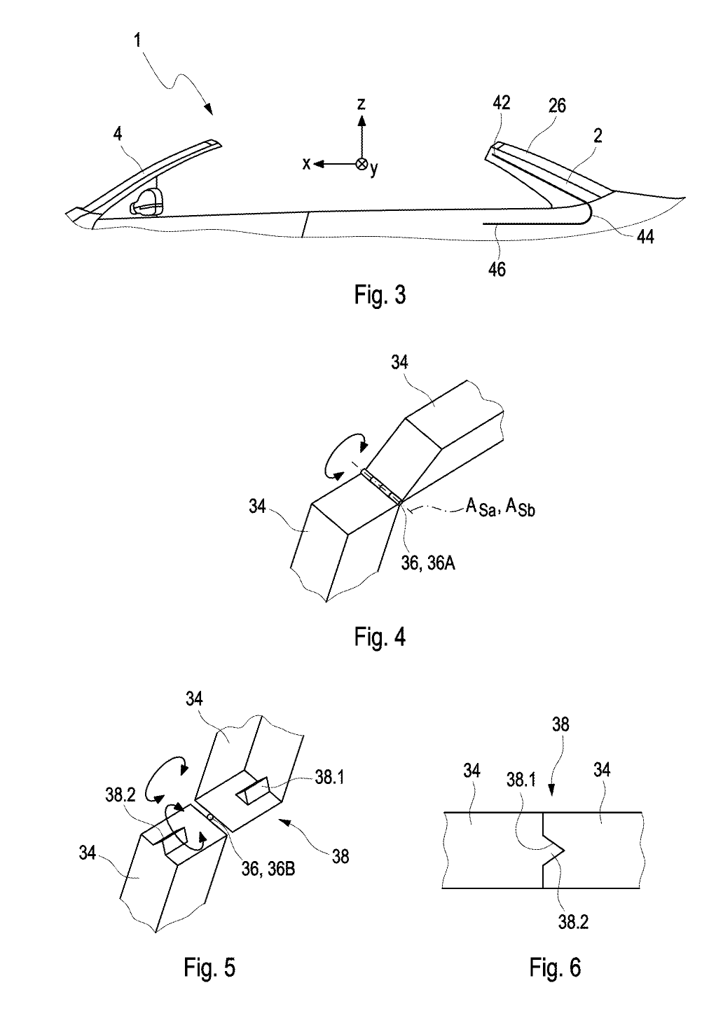

FIG. 3 a schematic lateral view of an upper sectional view of a vehicle with a schematic representation of the process for guiding the pushing and/or pulling device according to the invention of FIG. 1,

FIG. 4 a schematic representation of an embodiment of a link between two adjacent link elements of the pushing and/or puling device according to the invention, and

FIG. 5 a schematic representation of another embodiment of a link between two adjacent link elements of the pushing and/or pulling device according to the invention, and

FIG. 6 a schematic sectional view of the adjoining elements of FIG. 5 lying against each other,

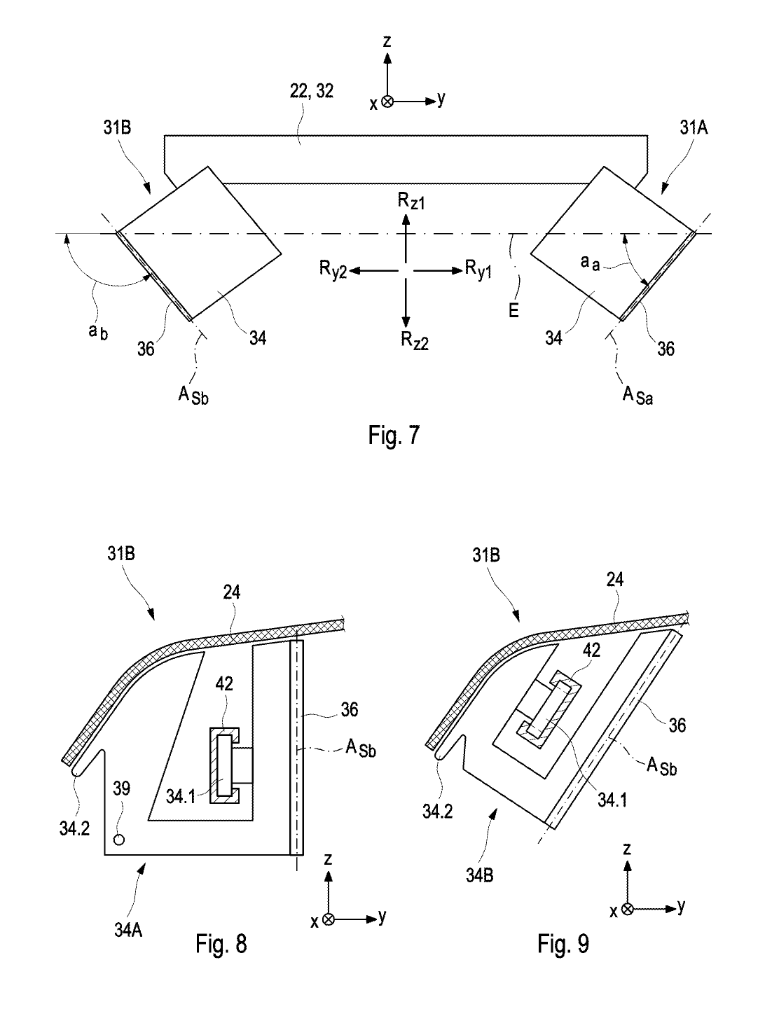

FIG. 7 a schematic sectional view of the pushing and/or pulling device according to the invention,

FIG. 8 a schematic sectional view of an embodiment of a link element of the pushing and/or pulling device according to the invention,

FIG. 9 a sectional view of another embodiment of a link element of the pushing and/or pulling device according to the invention.

As one can see from FIG. 1 through FIG. 9, the embodiments comprise a pushing and/or pulling device 30 according to the invention for a vehicle top, as well as two link chains 31A, 31B, which are provided with respective link elements 34, 34A, 34B, and which are deployed at a predetermined distance A to one another. The link chains 31A, 31B are guided at one end into a guide 40, which determines the movement direction T_{X1}, T_{X2} and the distance A of the link chains 31A, 31B to each other. These are mutually connected to each other at the other end by means of a transverse connection 32, so that the link chains 31A, 31B upon exiting the guide 40 extend on a joint plane E. In this case, two adjacent link elements 34, 34A, 34B are movably connected to each other, so that at least one part of the link elements 34, 34A, 34B of the link chains 31A, 31B are respectively connected to each other, and so that at least one part of the link elements 34, 34A, 34B is placed into a corresponding storage area 46 when the link chains 31A, 31B enter into the respective guide 40.

The adjacent link elements 34, 34A, 34B are placed upon exiting the respective guide 40 against each other and they are mutually supported against each other. According to the invention, the pivot axes A_{Sa}, A_{Sb} are provided between two adjacent link elements 34, 34A, 34B of the respective link element 31A, 31B a predetermined inclination angle Aₐ, A_{b} to the joint plane E. In this case, the pivot axes A_{Sa}, A_{Sb} of both link chains 31A, 31B are inclined against each other or run parallel to each other, so that the link chains 31A, 31B extend in a self-supporting manner in the predetermined movement direction Rₓ₁, Rₓ₂ and mutually block each other from other movement directions R_{y1}, R_{y2}, R_{z1}, R_{z2}.

The predetermined movement directions Rₓ₁, Rₓ₂ extend in the indicated embodiments essentially parallel to the vehicle's longitudinal direction x. The blocked movement directions R_{y1}, R_{y2}, R_{z1}, R_{z2} extend parallel to the vehicle's transverse direction y and to the height direction of the vehicle.

As a result of the described orientation of the pivot axes A_{Sa}, A_{Sb} of the adjacent link elements 34, 34A, 34B, a self-supporting pushing and/or pulling device 30 can be represented with two link chains 31A, 31B, which are simply rolled up in the relaxed or flexible state and/or stored in a storage area 46. The self-supporting effect is produced via the transverse connection 32 determining the predetermined distance A at one end of the link chain 31A, 31B, or when the respective guide 40 exits the between the link chains 31A, 31B, which causes a mutual support of the link chains 31A, 31B against each other, so that after exiting the guide 40, a mutual support is produced between the adjacent link elements 34, 34A, 34B of the respective link chains 31A, 31B.

As can be further clearly seen in FIG. 1 through 3, the illustrated embodiment comprises a rear roof bar 2, a windshield 41 and an openable vehicle roof with a folding top 20. The folding top comprises a plurality of folding top sections and a pushing and/or pulling device 30, which moves folding top sections from a usage position illustrated in FIG. 1 to a non-usage position illustrated in FIG. 2. As can be further seen from FIG. 1 through FIG. 3, a front folding top section 22 is designed as a rigid roof top, which is connected by means of at least one intermediate part, not shown here, to a rear rigid folding top section 26, which is provided with a rear window. As can be further seen from FIGS. 1 and 2, the front folding top section 22 forms the transverse connection 32 between the two link chains 31A, 31B. In this case, the front folding top sections 22 can be arranged in the non-usage position above or below the rear rigid folding top section 26.

The adjacent link element 34, 34A, 34B of the respective link chains 31A, 31B are mutually connected to each other in such a way that they can only be pivoted relative to each other about a predetermined pivot axis A_{Sa}, A_{Sb}. This means that the adjacent link elements 34, 34A, 34B of a first link chain 31A can also only pivot about a first pivot axis A_{Sa} and therefore they can be also angled between the adjacent link chains 31A, 31B. The adjacent link elements 34, 34A, 34B of a second link chain 31B can also be pivoted only by a second pivot axis A_{Sb}, so that the second link chain 31B can also be angled only about the second pivot axis A_{Sb} between the adjacent link elements 34, 34A, 34B. The adjacent link elements 34, 34A, 34B of the link chains 31A, 31B reinforce each other when a force is acting in the opposite direction of the respective pivot axis A_{Sa}, A_{Sb}, because the adjacent link elements 34, 34A, 34B are in contact and thus prevent angling. With the pivot axes A_{Sa}, A_{Sb} of the first link chain 31A and of the second link chain 31B, which are oriented in opposite directions, the first link chain 31A blocks with the predetermined distance A angling of the second link chain 31B about the second pivot axis A_{Sb}, and the second link chain 31B blocks with the predetermined distance A angling of the link chain 31A about the first pivot axis A_{Sa}.

As can be further clearly seen from FIG. 4, the joint 36 is in the illustrated embodiment realized as an inexpensive hinge 36A that is provided with a fixed predetermined pivot axes A_{Sa}, A_{Sb}.

As can be also seen from FIGS. 5 and 6, the joint 36 is designed in the illustrated example as a ball joint with variable pivot axes. In this embodiment, the connected adjacent link elements 34 connected via the ball joint 36B are provided with guide contours 38.1, 38.2, which mutually support adjacent link elements 34 against each other upon exiting the guide 40. In the illustrated embodiment, a first guide contour 38.1 is designed as a recess with a triangular cross-section, and a second guide control 38.2 is designed as an elevation with a corresponding triangular cross-section which is received in the recess.

As can be seen further also from FIG. 7 through 9, the inclination angle aₐ, a_{b} of the pivot axes

A_{Sa}, A_{Sb} to the joint plane E is predetermined in a value range that is more than 0° and less than 180°. The pivot axes A_{Sa}, A_{Sb} are between the adjacent link elements 34, 34A, 34B adapted to the conditions in the vehicle, in particular to the space that is available for the foldable top to be lowered and put away.

So for example, a first pivot axis A_{Sa} illustrated in FIG. 7 has a value of approximately 45° between the two adjacent link elements 34 of the first link chain 31, which are connected by means of a hinge 36. The second pivot axis A_{Sb}, which is inclined in the opposite direction to the first pivot axis A_{Sa}, has between two adjacent link element 34 of the link chain 31B, which is connected by means of a hinge 36, for example a value of approximately 135°.

A second pivot axis A_{Sb} shown in FIG. 8 between two adjacent link elements 34 of the second link chain 31B, which are connected via a joint 36, has for example with a value of approximately 90°. The corresponding first pivot axis A_{Sa}, not shown here, then has between two adjacent link elements 34 of the first link chain 31A also a value of 90°. A second pivot axis A_{Sb}, shown in FIG. 9, has between two adjacent link element 34 of the second link chain 31B, which are connected via a hinge 36, for example the value of approximately 60°. The corresponding first pivot axis A_{Sa}, not shown, then has between two adjacent link element 34 of the first link chain 31A a value of approximately 120°.

As can be clearly seen from FIG. 7 through 9, the individual link elements 34, 34A, 34B can have any form. In addition, the individual link elements 34, 34A, 34B of the respective link chains 31A, 31B can also have the same or different dimensions and/or forms. So for example, the first link elements 34, 34A, 34B of the respective link chain 31A, 31B, which are connected with a transverse connection, can have a different form and/or different dimensions than the other link elements 34, 34A, 34B. The link elements 34 illustrated in FIG. 7 are provided for example with a rhomboid-shaped cross-section. The link elements 34A, 34B shown in FIGS. 8 and 9 have for example different trapezoid-shaped cross-sections.

As can be seen for example from FIG. 1 through FIG. 3, the guide 40 comprises in the illustrated embodiment a load-bearing end section 42 and a connecting section 44, which defines a curved path for the corresponding link chain 31A, 31B between the load-bearing end section 42 and the storage area 46. In the illustrated embodiment, the load-bearing section 42, the connecting section 44 and the storage area 46 are respectively designed as guide rails, which are arranged within the link element 34, 34A, 34B. As an alternative, the load-bearing end section 42, the connecting section 44 and the storage area 46 can be respectively designed as guide rails which receive the link elements 34, 34A, 34B. Additionally, any combinations are conceivable. So for example, the load-bearing end section 42 can be arranged within the link elements 34, 34A, 34B and the connecting section 44 and the storage area 45 can receive the link elements 34, 34A, 34B.

As can be further seen from FIGS. 8 and 9, the link elements 34A, 34B are in the illustrated embodiment respectively provided with at least one guide element 34.1, which is guided into the load-bearing end section 42 prior to exiting the guide 40. In the case of the link element 34A illustrated in FIG. 8, the guide element 34.1 can be designed for example as a knob which is guided into the load-bearing end section 42 that is realized as a guide rail. In the case of the link element 34B illustrated in FIG. 9, the guide element 34.1 is designed for example as a roller which is moved to the load-bearing end section 42 designed as a guide rail. In addition, the guide 40 is provided with t least one drive element that is coupled to a drive, not shown in the figure, which moves the respective link chains 31A, 31B. The at least one drive element can be realized for example as a traction cable, or as a toothed wheel, a traction wheel, a worm wheel, or a belt.

As one can see further from FIGS. 8 and 9, a window seal 34.2 that is provided with a receiving slot is arranged on the link elements 34A, 34B, into which can be inserted a free edge of a side window. In addition, a convertible top 24 closes in the usage state the link elements 34A, 34B in the upward direction.

Embodiments of the invention represent a self-supporting pushing and/or pulling device for a vehicle top provided with two link chains, which can be rolled up in the relaxed or flexible state and/or stored in a simple manner in a storage area.

### LIST OF REFERENCE NUMERALS

1 vehicle
2 roof bar
4 windshield
20 foldable top
22 front foldable top section
24 foldable top material
26 rear foldable top section
30 pushing and/or pulling device
31A, 31B link chain
32 transverse connection
34, 34A, 34B link element
34.1 guide element
34.2 window seal
36 link
36A hinge
36B ball joint
38 guide structure
38.1 first guide contour
38.2 second guide contour
39 traction cable
40 guide
42 load-bearing end section
44 connecting section (curved path)
46 storage area
Rₓ₁, Rₓ₂, R_{y1},
R_{y2}, R_{z1}, R_{z2} movement direction
A_{Sa}, A_{Sb} pivot axis
aₐ, a_{b} inclination angle
E common plane
A distance
x vehicle's longitudinal direction
y vehicle's transverse direction
z vehicle's height direction

1-17. (canceled)

18. A Pushing and pulling device for a vehicle foldable top comprising:
two link chains, which are respectively provided with a plurality of link elements, and which extend at a predetermined distance to one another, wherein the link chains are respectively guided at one end in a guide, which predetermines a movement direction, and the mutual distance of the link chains to each other, and at the other end are connected to each other via a transverse connection, so that the link chains upon exiting the guide extend in a joint plane, wherein two adjacent link elements of the link chains are movably connected to each other via a joint, so that at least when the link chains enter into the respective guide, they are stored in a corresponding storage area, and wherein the adjacent link elements are upon exiting the respective guide lying against each other and support each other, wherein the pivot axes have between two adjacent link element of the respective link chain a predetermined inclination angle to the joint plane E, wherein the pivot axes of both link chains extend inclined to each other or parallel relative to each other, so that the link chains extend in a self-supporting manner in the predetermined movement direction and mutually block each other against other movement directions.

19. The pushing and pulling device according to claim 18, wherein the inclination angle, to the joint plane is predetermined in a value range that is more than 0° and less than 180°.

20. The pushing and pulling device according to claim 18, wherein in that the link is designed as a hinge with a fixed pivot axis, or as a ball joint with variable pivot axes.

21. The pushing and pulling device according to claim 20, wherein the adjacent link elements that are connected via a ball joint are provided with guide contours, which mutually support the adjacent link elements against each other upon exiting the respective guide.

22. The pushing and pulling device according to claim 21, wherein a first guide contour is designed as a recess and a second guide contour is designed as an elevation.

23. The pushing and pulling device according to claim 18, wherein the guide is provided with at least one drive element that is coupled to a drive which moves the respective link chains.

24. The pushing and pulling device according to claim 23, wherein the at least one drive element is designed as a traction cable, or a toothed wheel, or a traction wheel, a worm wheel, or a belt.

25. The pushing and pulling device according to claim 18, wherein the guide comprises a load-bearing end section and a connecting section, which determines a curved path for the corresponding link chain between the load-bearing end section and the storage area.

26. The pushing and pulling device according to claim 25, wherein the load-bearing end section and the connecting section and the storage area are designed as guide rails, which are arranged within the link elements.

27. The pushing and/or pulling device according to claim 25, wherein the load-bearing end section and the connection section and the storage area are designed as guide rails which receive the link elements.

28. The pushing and pulling device according to claim 25, wherein the link elements are respectively provided with at least one guide element, which is guided prior to exiting the guide in the load-bearing end section.

29. The pushing and pulling device according to claim 25, wherein the individual link elements of the respective link chains have the same or different dimensions and forms.

30. A folding top for an openable vehicle roof, comprising:
a plurality of folding top sections and with a pushing and pulling device, wherein the folding top sections are moved from a non-usage position to a usage position, wherein the pushing and pulling device includes:
two link chains, which are respectively provided with a plurality of link elements, and which extend at a predetermined distance to one another, wherein the link chains are respectively guided at one end in a guide, which predetermines a movement direction, and the mutual distance of the link chains to each other, and at the other end are connected to each other via a transverse connection, so that the link chains upon exiting the guide extend in a joint plane, wherein two adjacent link elements of the link chains are movably connected to each other via a joint, so that at least when the link chains enter into the respective guide, they are stored in a corresponding storage area, and wherein the adjacent link elements are upon exiting the respective guide lying against each other and support each other, wherein the pivot axes have between two adjacent link element of the respective link chain a predetermined inclination angle to the joint plane E, wherein the pivot axes of both link chains extend inclined to each other or parallel relative to each other, so that the link chains extend in a self-supporting manner in the predetermined movement direction and mutually block each other against other movement directions.

31. The folding top according to claim 30, wherein a front folding top section is designed as a rigid roof top which the at least one intermediate part is connected to a rear rigid folding section which is provided with a rear window.

32. The folding top according to claim 31, wherein the front folding top section forms a transverse connection between the two link chains.

33. The folding top according to claim 31, wherein the front folding top section is arranged in the non-usage position above or below the rear rigid folding top section.

34. The folding top according to claim 30, wherein on the link elements is respectively arranged a window seal with a receiving slot, in which can be inserted a free edge of a side window.
